(19) United States
(12) Patent Application Publication
(10) Pub. No.: US 2026/0168108 A1
(43) Pub. Date: Jun. 18, 2026

(54) FUEL CLADDING INTERACTIONS (FCI) RESISTANT COATING AND METHODS OF MAKING THE SAME

(71) Applicant: UCHICAGO ARGONNE, LLC, Chicago, IL (US)

(72) Inventors: Sumit Bhattacharya, Darien, IL (US); Abdellatif M. Yacout, Naperville, IL (US)

(73) Assignee: UCHICAGO ARGONNE, LLC, Chicago, IL (US)

(21) Appl. No.: 19/327,551

(22) Filed: Sep. 12, 2025

Related U.S. Application Data
(60) Provisional application No. 63/693,978, filed on Sep. 12, 2024.

(51) Int. Cl. C23C 28/00; C23C 28/04; G21C 21/02

(52) U.S. Cl. CPC C23C 28/3455; C23C 28/048; C23C 28/345; G21C 21/02

(57) ABSTRACT

A nuclear reactor coated cladding may include a steel cladding having opposed interior and exterior surface and a coating disposed on the interior surface, wherein: the coating is a thermal and radiation resistant multilayer coating comprising: a ceramic layer in contact with the steel cladding, a metal oxide region separated from the ceramic layer by a metal layer, a metal nitride region separated from the metal oxide region by a metal layer, and the metal nitride region comprises at least two metal nitride layers, the metal oxide region comprises at least two metal oxide layers, each metal oxide layer and each metal nitride layer is separated from an adjacent layer by a metal layer, and a thickness of the metal layers in the metal nitride region is greater than a thickness of at least one of the metal layers in the metal oxide region.

### CROSS REFERENCE TO RELATED APPLICATION

The benefit of priority to U.S. Provisional Application No. 63/693,978 filed Sep. 12, 2024, is hereby claimed and the disclosure is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates to coated claddings resistant to nuclear fuel induced thermal and radiation stresses named fuel-cladding interactions, as well as to methods of making fuel-cladding interactions resistant coated claddings.

### BACKGROUND

Nuclear power reactors provide about 10% of the world's electricity and about 18% of the USA electricity mostly from the use of water cooled and water-moderated reactors. In the interest of utilizing uranium fuel more efficiently, multiple concepts of fast reactors are being actively explored in both governmental and private domains. More efficient use of the fuel means that higher levels of fuel utilization or fuel burnup are achieved with fuel lives of 15 years, or more being targeted.

The sodium fast reactor (SFR), thanks to substantial U.S. experience with the Experimental Breeder Reactor II (EBR-11) and the Fast Flux Test Facility (FFTF), stands out for its advanced technological maturity. SFRs operate at higher temperatures and more displacements per atom (dpa) compared to light water reactors (LWR), which has led to the selection of higher conductivity metallic uranium-based fuels and ferritic-martensitic steel claddings to contain these fuels. A significant obstacle with this specific fuel-cladding pairing is the inter-diffusion between the fuel and cladding material, particularly at the anticipated high burnup levels, see FIG. 1A to FIG. 1D.

This fuel cladding chemical interaction (FCI) can result in the formation of compounds with lower melting points at the interface between the fuel and cladding, thereby reducing the effective thickness of the cladding wall. Fission-products of lanthanides, when transferred into the cladding, create a brittle, weak “wastage” zone, which lessens the failure threshold through creep-rupture (FIG. 1C).

The diffusion of iron from the steel cladding into the fuel generates a low-temperature eutectic phase with uranium and plutonium, raising the chances of localized fuel melting during high temperature transients (FIG. 1D). Previous studies also proposed that the transport of lanthanides could occur as liquid-like diffusion via interconnected pores filled with sodium and cesium. The liquid sodium bond used in conventional solid U—Zr fuels is believed to play a role in the transportation of lanthanides to the FCI region.

These potential failure modes have been primarily kept at bay by administrative controls like limiting peak cladding temperature and fuel burnup (i.e., the percentage of initial heavy metal atoms having been fissioned), providing effective protection against failures. However, these safety measures limit the lifetime of the fuel, leading to an increase in cost as the total energy output per fuel rod is reduced, thus alternative ways to mitigate the detrimental impact of FCI are being investigated. These include the use of different cladding alloys, diffusion barriers, cladding liners, and doped fuel alloys.

### SUMMARY

There remains a need in the art for improved coatings to mitigate or even entirely prevent problems associated with fuel cladding interactions. The coatings of the disclosure can advantageously be used to provide a coated cladding that is resistant to fuel-cladding interactions.

A coated cladding in accordance with the disclosure can include a steel cladding having opposed interior and exterior surfaces; and a coating disposed on the interior surface of the steel cladding. The coating is a thermal and radiation resistant multilayer coating including: a ceramic layer in contact with the steel cladding, a metal oxide region separated from the ceramic layer by a metal layer, a metal nitride region separated from the metal oxide region by a metal layer, and the metal nitride region includes at least two metal nitride layers and one or more metal layers, wherein each metal nitride layer is separated from an adjacent metal nitride layer by a metal layer of the one or more metal layers, the metal oxide region includes at least two metal oxide layers and one or more metal layers, each metal oxide layer is separated from an adjacent metal oxide layer by a metal layer of the one or more metal layers, the metal layer separating the metal nitride region from the metal oxide region is disposed between a metal nitride layer and a metal oxide layer, and a thickness of the one or more metal layers in the metal nitride region is greater than a thickness of at least one of the one or more metal layers in the metal oxide region.

A nuclear fuel rod in accordance with the disclosure can include a coated cladding as described herein and a nuclear fuel source including a Uranium-based alloy, a Uranium oxide, or combinations thereof contained within the nuclear fuel rod.

### BRIEF DESCRIPTION OF THE DRAWINGS

FIG. 1A is a scanning electron micrograph of the FCI in a conventional U-10Zr with HT-9 steel diffusion couple annealed at 700° C. for 96 h.

FIG. 1B is a scanning electron micrograph of the FCI in a conventional U-10Zr with T91 steel diffusion couple annealed at 740° C. for 25 h.

FIGS. 1C and 1D. are scanning electron micrographs of the crack and melt zone developed in the conventional U-10Zr with HT-9 steel diffusion couple shown in FIG. 1A.

FIG. 2 is a schematic of a nuclear reactor coated cladding according to the disclosure.

FIG. 3 is a schematic of a nuclear reactor coated cladding according to the disclosure.

FIG. 4A is a scanning electron microscopy image of a TiN on SS316 single layer coating after 12 hr thermal treatment.

FIG. 4B is a series of elemental maps of the TiN coating in FIG. 4A.

FIG. 5A is a cross section micrograph of a single layer Cr barrier on stainless steel.

FIG. 5B is a series of elemental maps of a selected area of FIG. 5A.

FIG. 6 is a scanning electron microscopy image of a cross section of a multilayer Cr/Al₂O₃ barrier on Fe substrate after annealing.

FIG. 7A is a scanning electron microscopy image of a multilayer TiN/Cr barrier on SS316 after annealing.

FIG. 7B is a series of elemental maps of a region of the barrier in FIG. 7a.

FIG. 8A is a scanning electron microscopy image of a multilayer Cr/Y₂O₃ barrier on SS 316 substrate after annealing for 12 hr.

FIG. 8B is a series of elemental maps of a selected area of FIG. 8B.

FIGS. 9A and 9B are backscattered electron images of a polished cross section of sub-stoichiometric Yttria deposited over an HT-9 substrate and pressed against a Misch metal disc.

FIGS. 9C and 9D are backscattered electron images of a polished cross section of stoichiometric Yttria deposited on HT-9 and pressed against a Misch metal disc.

FIG. 10A is a backscattered electron image of the polished cross section of FIG. 9A after being treated at 650° C. for 24 hours.

FIGS. 10B to 10E are EDS maps of the cross section in FIG. 9A showing the elemental distribution of Y, Fe, Ce and La.

FIG. 11A. is a backscattered electron image of the polished cross section of FIG. 9C after being treated at 650° C. for 24 hours.

FIGS. 11B to 11E are EDS maps of the cross section in FIG. 9C showing the elemental distribution of Y, Fe, Ce and La.

FIG. 12 is a picture of the stage (left) and the sample holder (right) used in ion radiation experiments.

FIG. 13A is a micrograph of a cross-section of a single Cr layer barrier on SS316 after radiation treatment.

FIG. 13B are EDS maps of the barrier shown in FIG. 13A.

FIG. 14 is a scanning electron microscopy image of a multilayer Cr/Al₂O₃ barrier on SS316 substrate after being irradiated at 650° C.

FIG. 15 is a micrograph of a cross-section of a multilayer Cr/CrY/Y₂O₃ barrier on SS316 substrate after being irradiated at 650° C.

FIG. 16 is an Ellingham stability diagram of the Gibbs free energy of formation of different oxides.

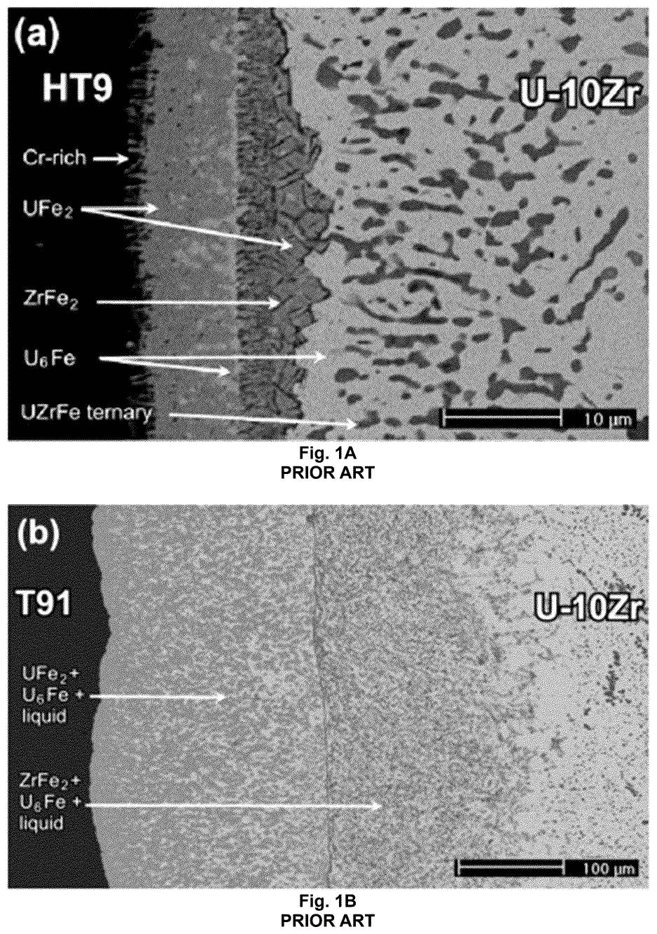

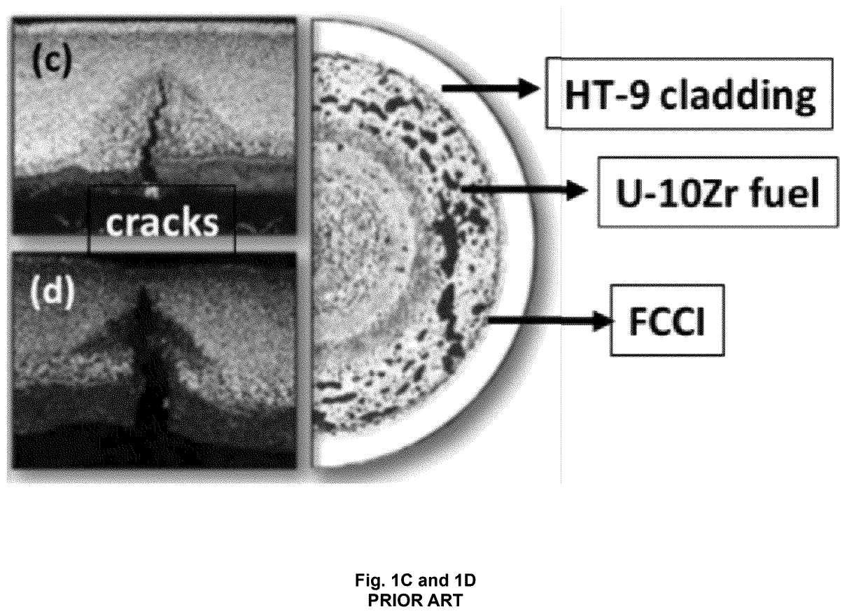

### DETAILED DESCRIPTION

Coated claddings according to the disclosure advantageously provide an improved diffusion barrier coating, with a thickness gradient design, where the materials are selected to prevent solid fission product/Uranium diffusion at high temperatures. For example, coated claddings of the disclosure maintain radiation resistance at transient temperatures up to about 800° C. Composition and thickness of individual layers can be tailored to achieved desired barrier properties against radiation damage such as bubble formation from gaseous fission products without having to increase thickness, thereby maximizing the amount of nuclear fuel per volume. The FCI-resistant coating of the disclosure can prevent formation of low melting lanthanide alloys, particularly those containing Ce.

The coated claddings of the disclosure can be useful, for example, in nuclear reactors.

As used herein, transient temperature refers to the temperature of a nuclear reactor during a non-steady state, in this state the reactor parameters can rapidly change. Transient conditions can happen during various events, such as changes in reactor power demand, control rod movements, or equipment failures. Coatings of the disclosure can withstand transient temperatures in the range from about 600° C. to about 1000° C. Operating temperature, as used herein, refers to the temperature of a nuclear reactor once a steady state condition is achieved. Coatings of the disclosure can withstand operating temperatures in the range from about 500° C. to about 700° C. for example above 500° C. to 700° C.

Coated claddings according to the disclosure can include a steel cladding having an interior surface and an exterior surface. The coated claddings of the disclosure can further include a thermal and radiation resistant coating deposited on the interior surface of the steel cladding. According to the disclosure, the coating applied to the interior surface of the steel cladding can include a ceramic layer in direct contact with the steel cladding, a metal oxide region, and a metal nitride region. The coated cladding of the discloser can further include metal layers separating each of the ceramic layer from the metal oxide region, and the metal nitride region from the metal oxide region.

The metal oxide region can have two layers or more and one or more metal layers. Each metal oxide layer can be separated from an adjacent metal oxide layer by a metal layer.

The metal nitride region can have two or more metal nitride layers, each layer separated by metal layers. A thickness of the metal layers in the nitride region is greater than a thickness of the metal layers in the metal oxide region.

Coated claddings according to the disclosure can have a gradient of thickness of metal layers in the coating. The thickness of the metal layers can decrease from the nitride region to the metal layer separating the metal oxide region from the ceramic layer, i.e. the largest thickness of the metal layer is of the layer closest to the nuclear fuel source. It is contemplated that the gradient can be a continuously decreasing thickness gradient from the metal nitride region to the metal oxide region or can have a stepwise decrease in thicknesses, optionally in which one or more metal layers in the same region has the same thickness, but an overall trend of thickness is decreasing in the structure from the metal nitride region to the metal oxide region.

The thickness of each of the metal layers can be selected, such that the ratio of the metal atoms in the layer to implanted fission products, for example Ce, remains at least 90 at. % at any time during the lifetime of the fuel. That is, selected such that the concentration in each metal layer of implanted solid fission products from radioactive fuel decay is 10 at. % or less, throughout the lifetime of the nuclear fuel source. If the thickness of the metal layers is less than the thickness needed to maintain the concentration of fission products at 10 at. % or less, the accumulation and implantation of lanthanides may lead to formation of alloys with the components of the steel clad that may include eutectic phases of low melting points where localized melting failure may occur.

The metal layers in the metal nitride region can have a thickness of about 2000 nm to about 3000 nm. For example, the thickness of a metal layer in the metal nitride region can be about 2000 nm, or about 2200 nm, or about 2400 nm, or about 2500 nm, or about 2600 nm, or about 2800 nm, or about 3000 nm or any values therebetween or ranges defined by these values. Furthermore, the metal layer separating the metal nitride region from the metal oxide region can have substantially the same thickness as the one or more metal layers of the metal nitride region.

The metal layers in the metal oxide region can have a thickness of about 300 nm to about 2500 nm. For example, the thickness of a metal layer in the metal oxide region can be about 300 nm, or about 500 nm, or about 600 nm, or about 800 nm, or about 1000 nm or about 1200 nm, or about 1400, nm, or about 1600 nm, or about 1750 nm, or about 2000 nm, or about 2250 nm or about 2500 nm, or any values there between or ranges defined by these values. At least one of the metal layers in the metal oxide region can have a thickness substantially the same as a thickness of the metal layer separating the metal oxide region and the metal nitride region. The coated cladding can include at least one metal layer in the metal oxide region having a thickness that is less than the thickness of the metal layer separating the metal oxide region and the metal nitride region.

The metal nitride layers of the metal nitride region can have substantially the same thickness. Each metal nitride layer can have a thickness of about 250 nm to about 350 nm. For example, each metal nitride layer can have a thickness of about 250 nm, or about 275 nm, or about 300 nm, or about 325 nm, or any values therebetween or ranges defined by these values. Metal nitride layers of varying thickness within the metal nitride region are also contemplated herein.

The metal oxide layers of the metal oxide region can have substantially the same thickness. Each of the metal oxide layers can have a thickness from about 500 nm to about 1.5 microns. For example, each metal oxide can have a thickness of about 500 nm, or about 600 nm, or about 750 nm, or about 1000 nm, or about 1.2 micron, or about 1.4 micron, or about 1.5 micron, or any values therebetween or ranges defined by these values. It has been observed that thicknesses of less than 500 nm can result in fission products being released from the fuel, which can become implanted in the metal layers increasing the potential of alloy or bubble formation. Metal oxide layers of varying thickness within the metal oxide region is also contemplated herein.

Cladding coatings of the disclosure can have a total thickness of about 6 microns to about 15 microns. For example, total coating thickness can be about 6 microns, or about 7.5 microns, or about 9 microns, or about 10 microns, or about 12 microns, or about 15 microns, or any values therebetween or ranges defined by these values. It has been observed that coatings in accordance with the disclosure can be effective barriers and/or mitigate fuel cladding interactions at such coating thicknesses, which are thinner than required by conventional coatings. It has been observed that coatings with a total thickness of less than about 6 microns are not capable of preventing fission products from reaching the steel cladding, which can be detrimental to the lifetime of the fuel. For example, fission products can breach a barrier that is too thin reaching and interacting with the cladding directly, which can lead to local changes in microstructure of the cladding and formation of weak spots where the cladding can crack. In nuclear fuel rod configurations where a sodium bond is used to enhance the thermal conductivity of the fuel, a failure in the coating is believed to lead to loss of the sodium bond which can cause an increase in fuel temperature. This can result in increased migration of fission products and consequently accelerated degradation of the cladding. Fuel rods in danger of having the cladding breached are retired from use for safety reasons, which reduces the time/amount of fuel usage.

Coatings of the disclosure can have a total number of layers of about 4 to about 11. For example, the coatings can have about 1 to about 2 nitride layers in the metal nitride region. For example, the coatings can have about 3 to about 4 metal oxide layers in the metal oxide region. Remaining layers can be metal layers and the ceramic layer.

The ceramic layer can have a thickness of about 200 nm to about 250 nm. Without intending to be bound by theory, it is believed that when the thickness of the ceramic layer is above 250 nm, the layer may fracture at operating or transient temperature due to excessive thermal conductivity mismatch between the steel cladding and the ceramic layer. If the thickness of the ceramic layer is below 200 nm, the ceramic layer may not be able to effectively protect the steel cladding from fuel products induced corrosion.

The ceramic layer is deposited directly on the steel cladding and can include one or more of TiN, Cr₂O₃, Y₂O₃, and ZrO₂.

The metal nitrides in the metal nitride region can be any one or more nitrides that do not react with uranium-based alloys or solid fission products at operational and transient temperatures. Solid fission products generated during the decay of the nuclear fuel include, but are not limited to, La, Sm, Ce, Nd, and Pr. Suitable nitrides can be any one or more of TIN, ZIN, YN, CrN, and other metal nitrides with a Gibbs free energy of formation lower than the Gibbs free energy of formation of Uranium nitride at temperatures between about 600° C. to about 1000° C., or between about 100° C. to about 800° C.

In cladding coatings of the disclosure, the metal oxide layers can include one or more metal oxides capable of forming thermally and chemically stable garnets with rare earth elements and are radiation resistant. The metal oxides can comprise Yttria (Y₂O₃), Yttria-stabilized zirconia, alumina (Al₂O₃), lanthanide-doped yttria, lanthanide doped yttria stabilized zirconia, lanthanide-doped alumina, chromia (Cr₂O₃) or combinations thereof. For example, the metal oxides can be stoichiometric oxides. If the metal oxide layer is oxygen deficient, the layer may not be as effective as diffusion barrier to fission products as vacancies in the crystal lattice of the oxide would allow diffusion of fission products through the metal oxide layer. Sub-stoichiometric oxides can be used herein but may require increased thickness of the oxide layer and/or total coating thickness.

The coated cladding of the disclosure can include a plurality of metal layers separating the metal nitride layers and metal oxide layers. The metal layers can be either a pure metal, a doped metal, or an alloy that can form a eutectic phase with Uranium having a melting point higher than about 600° C. During nuclear fuel decay, the metal in the metal layers interacts with the fission products, e.g. lanthanides, forming alloys. If the eutectic phases of the alloys formed between the lanthanides and the metal in the metal layers have a melting point lower than 600° C., localized melting of the coating can occur. As localized melting happens, areas devoid of metal and areas with excess metal can form at the interface between the metal layer and the adjacent metal oxide or metal nitride layer. The excess metal can exert stress on the adjacent metal oxide or metal nitride layer leading to cracking of the layer and forming further voids through which fission products can diffuse.

The metal layers can include one or more of Cr, V, Ti, Mo, Zr, Y, combinations thereof, and alloys thereof. For example, the metal can be a 60 at. % Cr-40 at. % Y alloy, or an alloy containing a 1:1 atomic ratio of Zr and Cr, or a 60 at. % Zr-40 at. % Y alloy. For example, the metal can be a Cr—Y alloy containing Cr in an amount between about 45 at. % to about 95 at. % and Y in an amount between about 5 at. % to about 55 at. %. For example, the metal can be a Cr—Ti alloy containing Cr in an amount between 60 at. % to about 70 at. % and Ti in an amount between about 30 at. % and 40 at. %.

The metal layers can include or be formed of doped metals. For example, dopants used in the metals of the metal layer can include Al and Y. For example, the dopant can have a concentration of about 5 at. % to about 10 at. %. For example, the dopant can have a concentration of about 5 at. %, or about 6 at. %, or about 7 at. %, or about 8 at. %, or about 9 at. %, or about 10 at. %, or any values therebetween or ranges defined by these values.

The metal layers in the cladding coating can have all have the same composition, or all or some subset of the metal layers can have different compositions. For example, at least two metal layers can have the same composition.

In another aspect of the disclosure, a nuclear fuel source is surrounded by the coated cladding and the nuclear fuel source is in contact with a nitride layer of the metal nitride region of the cladding coating.

The nuclear fuel source can be a Uranium based alloy, a uranium oxide, or a combination thereof. For example, the nuclear fuel source can be UO₂ pellets.

According to the disclosure, a fuel rod include a cladding with a coating in accordance with the disclosure disposed on an interior surface of the cladding. The coating can be arranged such that a nitride layer in contact with the nuclear fuel source. The fuel rod can be, for example, an internally coated stainless steel cladding tube and the tube can contain a nuclear fuel source, particularly in the form of fuel pellets.

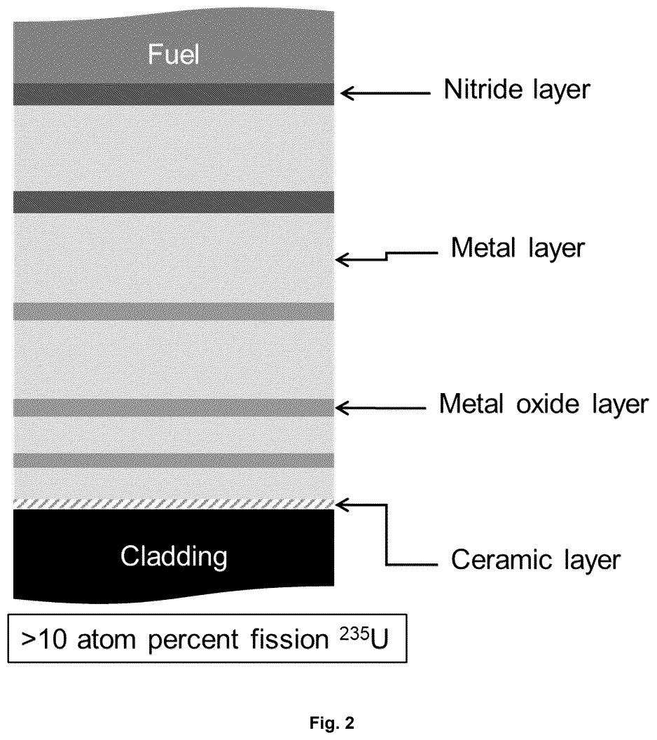

Referring to FIG. 2, an example arrangement of layers for a coating of the disclosure is shown. In the embodiment shown, the coated cladding has a first metal layer separating the metal oxide region form the ceramic layer. The metal oxide region can include a first, a second and a third metal oxide layers separated by a second and a third metal layers. The coated cladding can have a fourth metal layer separating the metal oxide region from the metal nitride region and have a fifth metal layer separating a first metal nitride layer from a second metal nitride layer. The first and second nitride layers can have a thickness that is substantially the same; the first, second and third oxide layers can have a thickness that is substantially the same; the first and second metal layers can have a thickness that is substantially the same; the third, fourth and fifth metal layers can have a thickness that is substantially the same; and the thickness of the third, fourth, and fifth metal layers is greater than the thickness of the first and second metal layers.

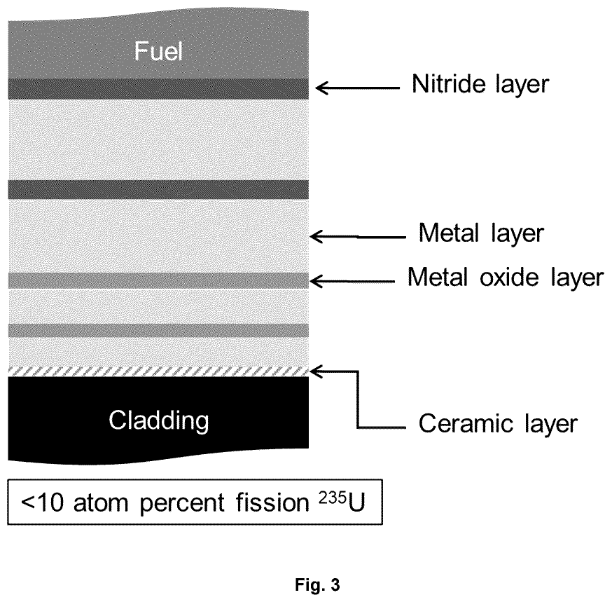

Referring to FIG. 3, an example arrangement of layers for a coating of the disclosure is shown. In the embodiment shown, the coated cladding according to the disclosure can have a first metal layer separating the metal oxide region form the ceramic layer. The metal oxide region can include a first, and a second metal oxide layers separated by a second metal layers. The coated cladding can have a third metal layer separating the metal oxide region from the metal nitride region and have a fourth metal layer separating a first metal nitride layer from a second metal nitride layer. The first and second nitride layers can have a thickness that is substantially the same; the first and second oxide layers can have a thickness that is substantially the same; the first and second metal layers can have a thickness that is substantially the same; the third and fourth metal layers can have a thickness that is substantially the same; and the thickness of the third and fourth metal layers is greater than the thickness of the first and second metal layers.

The coatings of the disclosure, and layers making up the coatings of the disclosure can be formed by techniques that are well-known in the art. For example, combination of deposition techniques can be applied to achieve the final gradient design. For example, the ceramic layers can be applied via electrophoretic deposition (EPD), atomic layer deposition (ALD), chemical vapor deposition (CVD) or a combination thereof. For example, the metal layers can be applied utilizing physical vapor deposition (PVD) or electrochemical deposition (ECD). ALD is particularly contemplated for the deposition of ceramic layers as this process inherently leads to production of pin hole free coatings which are ideal to prevent high temperature diffusion.

### EXAMPLES

Layer thicknesses and compositions were tested for long term reliability against U/lanthanides diffusion. Focus was placed on mitigating the impact of solid fission product implantation depth from products released form the outermost surface of the metal fuel.

### Example 1

Layer thickness calculation. It was assumed that a fission reaction releases 200 MeV energy on average where 169 MeV are carried by the two fission products in the form of kinetic energy while the rest of the energy is shared by 23 fast neutrons, gamma emission, and delayed energy. SRIM software was used to estimate the absolute depth reached by solid fission products released from the outer surface of the metal fuel with ˜84 MeV (i.e., 169/2 MeV) within different coating designs.

The thickness of the metal layers was calculated to ensure that the concentration of fission products implanted into the barrier during a particular fuel usage, remained under 10% to prevent formation of low melting temperature phases that would cause localized melting.

Metal layer thicknesses were calculated for two fuel usage levels (burnups); a <10 at. % fission and a long fuel life burnup >10 at. % fission.

For this calculation, a Cr metal layer was selected, and the fission products were represented by the amount of Ce isotopes released by a ²³⁵U-based fuel.

The typical concentrations of Ce isotopes in ²³⁵U decay have been reported for a 0.1 g sample to be about 40×10¹⁷ atoms. Conservatively, it was assumed that about 20% of these released fission products diffuse or get implanted into the barrier, particularly within the first few layers of the barrier.

A typical U-10Zr pellet (9.5 mm diameter×16 mm height) contains about 3.6 g of ²³⁵U. Considering a 10 at. % burnup and a 20% implantation rate, the amount of Ce isotopes to be captured in the barrier was calculated as:

$${Ce}_{yield} = 3.6 g {}^{235} U \times 10 at . \% fission \times \frac{40 \times {10}^{17} atoms}{0.1 g {}^{235} U} \times 20 \% implantation rate ≅ 24 \times {10}^{17} atoms @ 10 at . \%$$

The number of Cr atoms to maintain Ce at a 10% concentration within the first metal layer was calculated based on the Ce_{yield} as follows:

$$No . Cr atoms = \frac{{Ce}_{yield} \times 100 \%}{10 \%} = \frac{24 \times {10}^{17} \times 100 \%}{10 \%} ≅ 2.5 \times {10}^{19} Cr atoms$$

The same calculations were performed for 25 at. % fission, and the results are summarized in table 1.

TABLE 1

| | Total Ce_{yield} from a | Ce_{yield} at 20% | |
|---|---|---|---|
| Atom % | U-10 Zr pellet | implantation | Cr atoms needed in |
| fission ²³⁵U | (atoms) | (atoms) | the first metal layer |
| 10 | 12 × 10¹⁸ | 2.4 × 10¹⁸ | ~2.5 × 10¹⁹ atoms of Cr |
| 25 | 40 × 10¹⁸ | 8.0 × 10¹⁸ | ~8.0 × 10¹⁹ atoms of Cr |

The number of Cr atoms in a layer of thickness (t) deposited in the interior surface of a cylindrical cladding with interior diameter (ID) and height (h) was calculated using the molecular weight of Cr (MW), the density of chromium (p) and the Avogadro's number (Å) as follows:

$$Cr atoms = {V}_{annular section} \times \frac{Å}{MW} ρ = \frac{π h}{4} ( {ID}^{2} - {( ID - t )}^{2} ) \times \frac{Å}{MW} ρ$$

Table 2 shows the estimated number of Cr atoms for several layer thicknesses. The last column compares the number of Cr atoms in the layer vs, the required number of Cr atoms reported in table 1 for a specific burnout.

TABLE 2

| | | | Satisfies the minimum |
|---|---|---|---|
| Top Metal layer | Cladding ID | Number of | thickness requirement for the |
| thickness (μm) | (mm) | atoms per layer | metal layer |
| 1.0 | 6.6 | 3.8 × 10¹⁸ | No |
| 1.5 | 6.6 | 4.1 × 10¹⁹ | Yes (≤10 atom % fission) |
| 3.0 | 6.6 | 8.2 × 10¹⁹ | Yes (≤25 atom % fission) |

### Comparative Example 1

A 500 nm single layer of TiN was deposited on stainless steel (SS 316) via radio frequency (RF) powered magnetron plasma sputtering. The film was subject to 10 annealing cycles, where the temperature was ramped up from room temperature to 700° C. at a rate of about 135° C./hr., once 700° C. was reached the temperature was held for 1 hr and then ramped back down to room temperature at about the same rate.

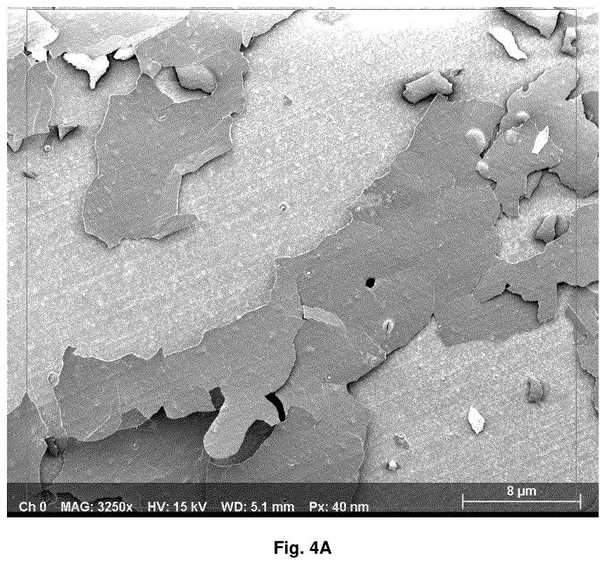

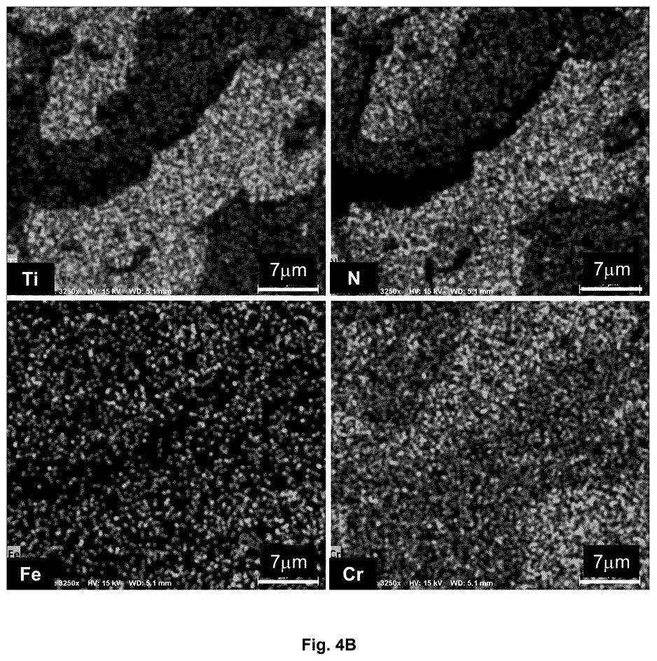

It was observed that after 10 annealing cycles the TiN layer delaminated (FIG. 4A-4B), illustrating that a single TiN layer barrier could not be used as an effective barrier due to the loss of mechanical integrity after thermal exposure.

### Example 2

Cladding coatings with different number of metal and ceramic layers were prepared and tested for lanthanide thermal diffusion.

Stainless steel and iron discs substrates were used as representative materials used in fuel cladding rods.

The composition and number of layers of each coating and the deposition methods used are shown in Table 3. A Ce layer was deposited on top of the barrier as a model lanthanide.

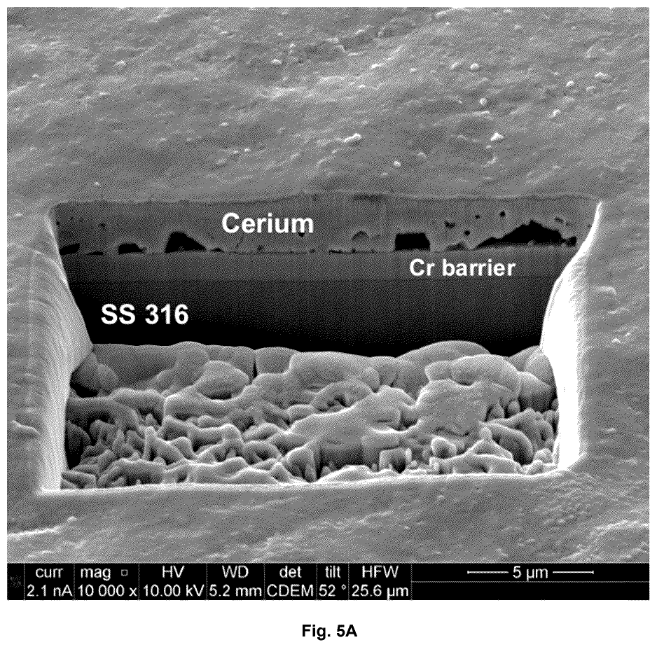

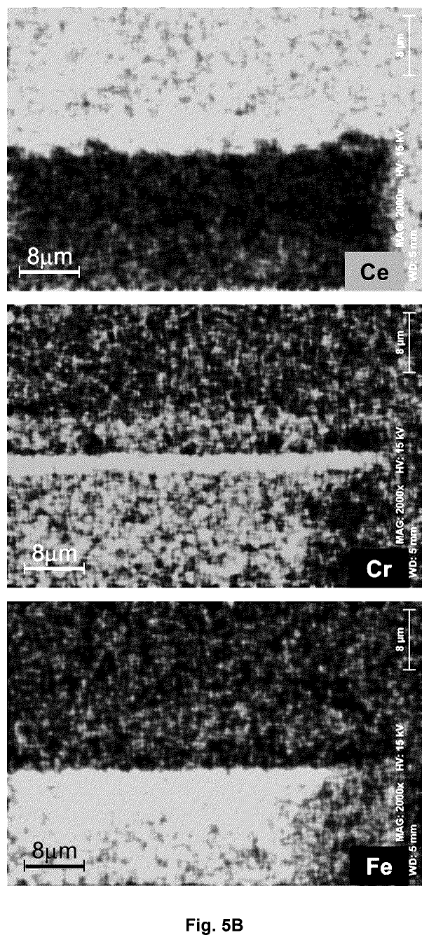

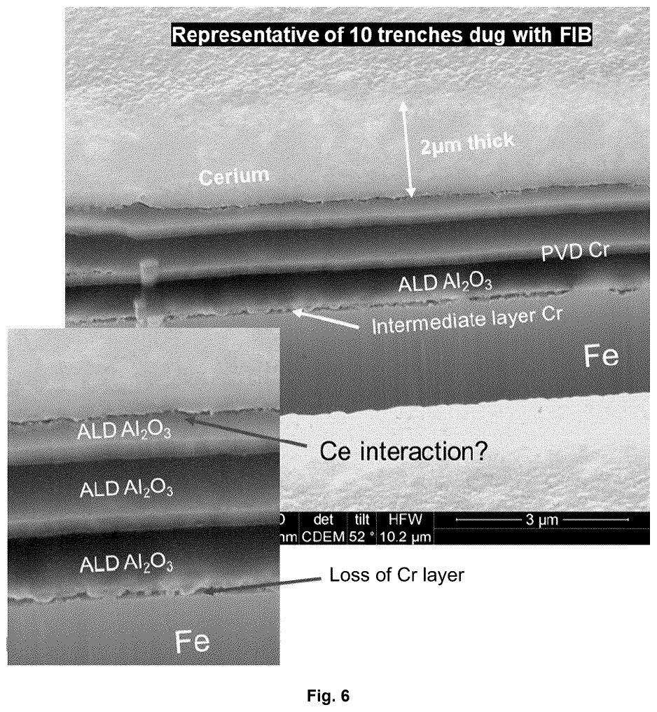

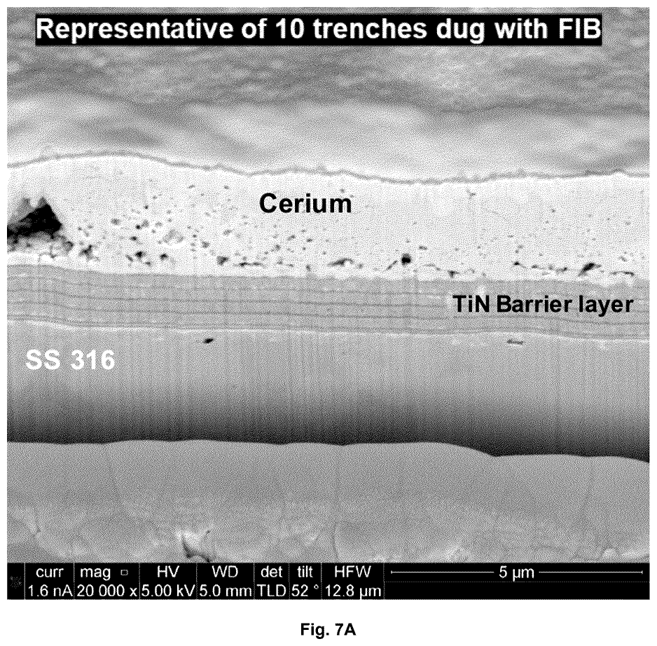

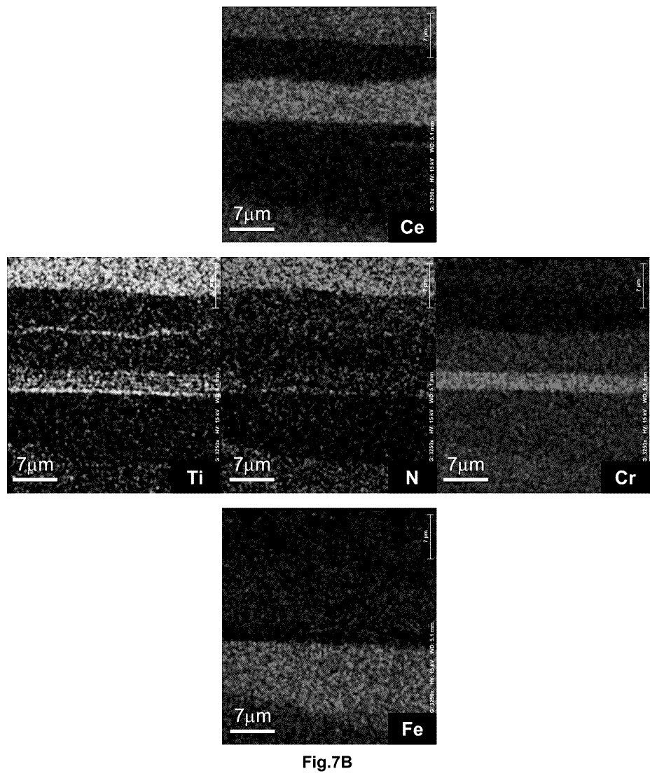

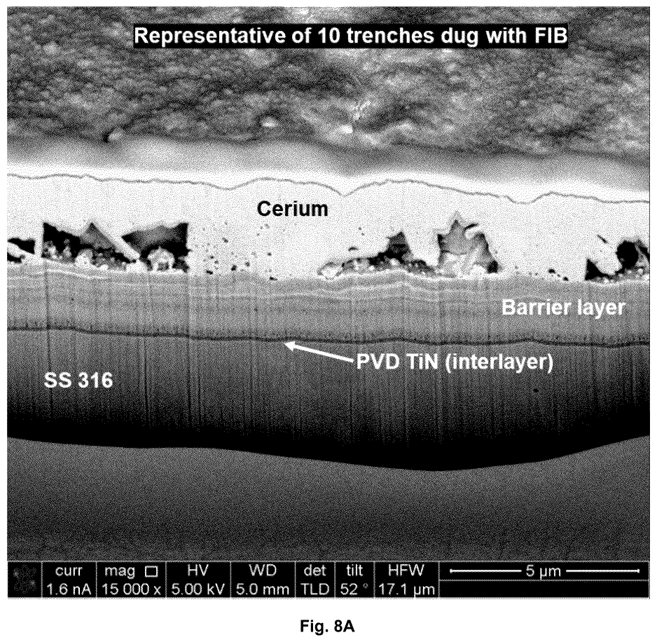

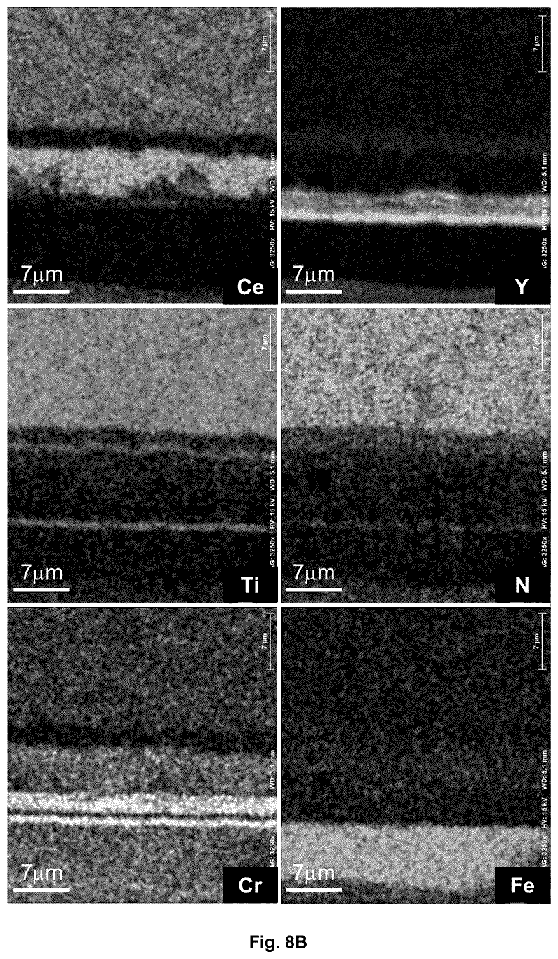

TABLE 3

| | Sample | 2A | 2B | 2C | 2D |
|---|---|---|---|---|---|
| Substrate | Material | SS316 | Fe | SS316 | SS316 |
| | Barrier | Cr | Cr | TiN | TiN |
| | interface | | | | |
| Metal | Metal | — | Cr | Cr | Cr—Y |
| layers | No of layers | — | 3 | 3 | 3 |
| | Thickness | ~1.2 μm | ~200 nm | ~250 nm | ~250 nm |
| | (nm) | | | | |
| | Deposition | PVD | PVD | PVD | PVD |
| | method | | | | |
| Ceramic | Ceramic | — | Al₂O₃ | TiN | Y₂O₃ |
| layers | No of layers | — | 3 | 3 | 3 |
| | Thickness | — | 600 | 100 | 100 |
| | (nm) | | | | |
| | Deposition | — | ALD | PVD | PVD + |
| | method | | | | thermal |
| | | | | | oxidation |
| | Result | Limited Ce | No Ce | No Ce | No Ce |
| | | migration | migration | migration | migration |
| | | observed. | observed. | observed. | observed. |
| | | (FIG. 5A-5B) | Cr interface | (FIGS. 7A- | (FIGS. 8A- |
| | | | diffused into | 7B) | 8B) |
| | | | the | | |
| | | | substrate. | | |
| | | | (FIG. 6) | | |

The metal layers in diffusion Sample 2D were a Y-doped Cr, achieved by PVD deposition of Y on top of the Cr layer. An excess Y was deposited and partially oxidized to form the corresponding ceramic Y₂O₃ layer.

The coated discs were annealed for 12 hr at 650° C. After the annealing process, samples were cross sectioned using Focus ion Beam (FIB). Scanning electron microscopy images and elemental EDS mappings of the cross sections were taken to analyze Ce migration through the barrier coatings.

Comparative barrier coatings 2A and 2B showed that while a Cr layer in direct contact with the cladding limits Ce diffusion, the Cr is able to diffuse into the substrate, limiting the lifetime of the barrier.

Without intending to be limited by theory, it is believed that a ceramic layer in direct contact with the stainless-steel cladding is beneficial to preventing migration of the metal in the metal layer into the cladding as well as to prevent lanthanide diffusion.

### Example 3

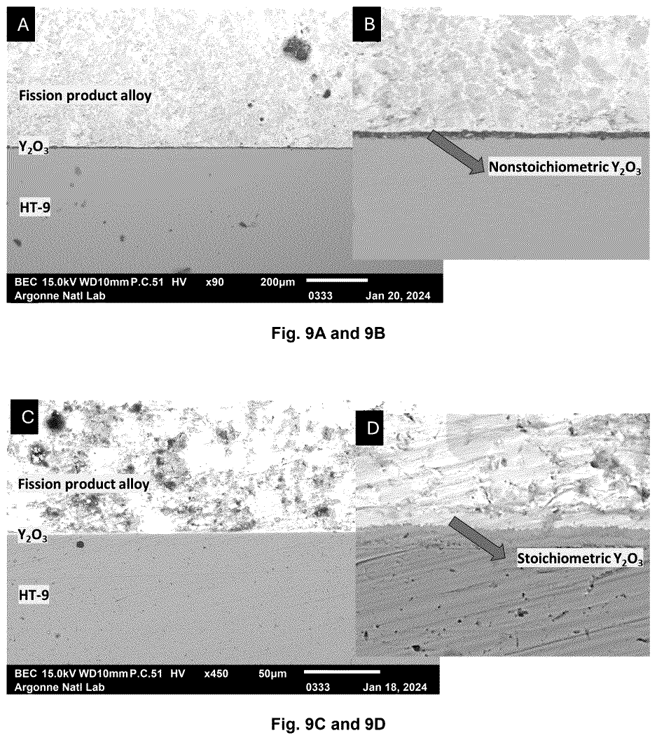

Diffusion models were prepared to compare the barrier efficiency of stoichiometric yttria (Y₂O₃) versus sub-stochiometric yttria (Y₂O₃₋ₓ) coatings against solid fission products. FIG. 9A-9B show a cross section of the diffusion model for non-stoichiometric yttria and FIG. 9C-9D show a cross section of the diffusion model for stoichiometric yttria.

The yttria layers were prepared by depositing a layer of pure metallic yttrium (Y) layer on HT-9 steel using Physical vapor deposition (PVD). This was followed by a controlled oxidation step at 700° C. for 2 hours.

The sub-stochiometric Y₂O₃₋ₓ layer was achieved by controlling the amount of air going into the furnace during thermal oxidation. The pressure maintained during the time of oxidation was about 0.002 atm.

The stochiometric layer Y₂O₃ was prepared by allowing continuous flow of air into the furnace during oxidation. The pressure maintained during the time of oxidation was 1 atm.

The yttria coated HT-9 steel substrates were pressed against Misch metal discs as lanthanide source. Misch metal is an alloy of iron with rare elements including La, Ce, Pr and Nd, which are the main lanthanides released during nuclear fuel decay.

Samples were treated at 650° C. for 24 h to stimulate diffusion. After the thermal treatment, samples were cross sectioned for analysis.

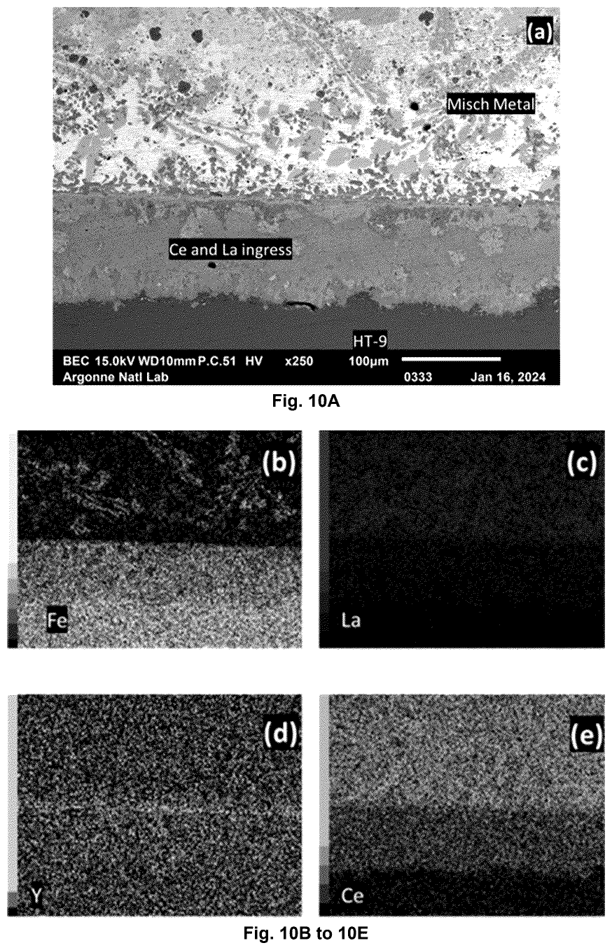

Electron microscopy images and EDS mapping (FIG. 10A-10E) of the system containing the non-stoichiometric yttria showed that this layer was ineffective to prevent diffusion/migration of lanthanides. Three regions can be observed in FIG. 10A, with the central region being an alloy of Fe from the HT-9 steel and La and Ce from the Misch metal.

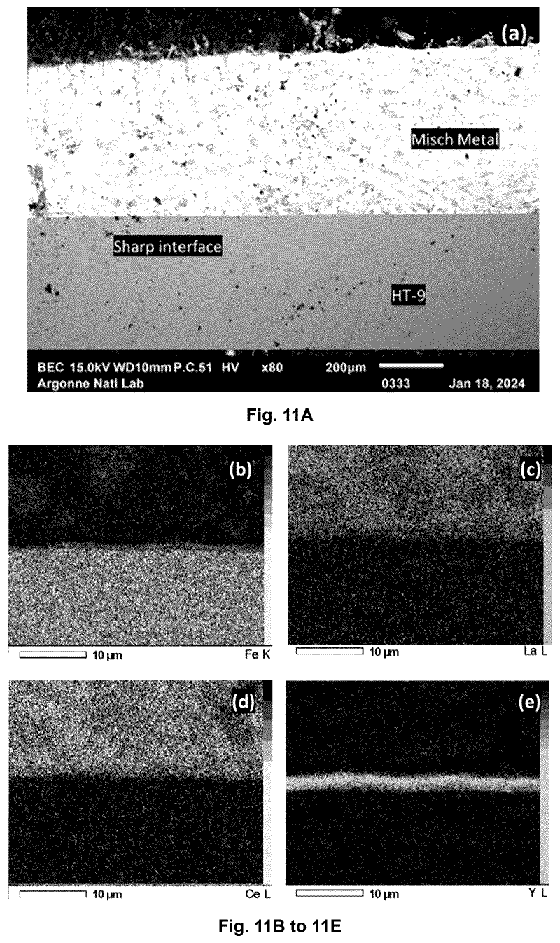

In contrast, the system containing the stoichiometric yttria layer showed an intact barrier layer after heat treatment (FIG. 11E) and no interdiffusion of La or Ce into the HT-9 layer as demonstrated by the two distinct regions in FIG. 11A and the elemental distribution of Fe, La and Ce (FIG. 11B-11D).

### Example 4

In addition to thermal induced diffusion, a series of barrier coatings in accordance with the disclosure were tested under radiation at reactor operator temperatures (650° C.)

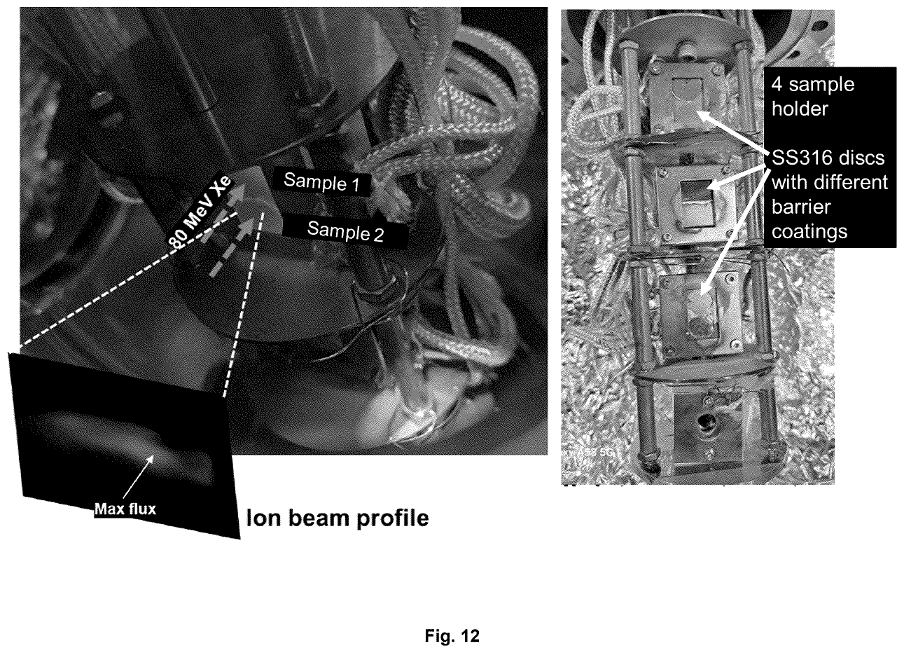

A 4-slot sample holder (FIG. 12) was used to simultaneously expose multiple samples to a dose of about 4.53 E16 ions/cm² for 12 hr. FIG. 12 shows a picture of the stage where the sample holder was inserted and a picture of the ion beam profile.

Stainless steel and iron discs substrates were used as representative materials used in fuel cladding rods.

The composition and number of layers of each coating and the deposition methods used are shown in Table 4. A Ce layer was deposited on top of the barrier as a model lanthanide. The Ce side faced the ion beam, and a combination of radiation and thermal stress were used to stimulate diffusion of Ce through the barrier.

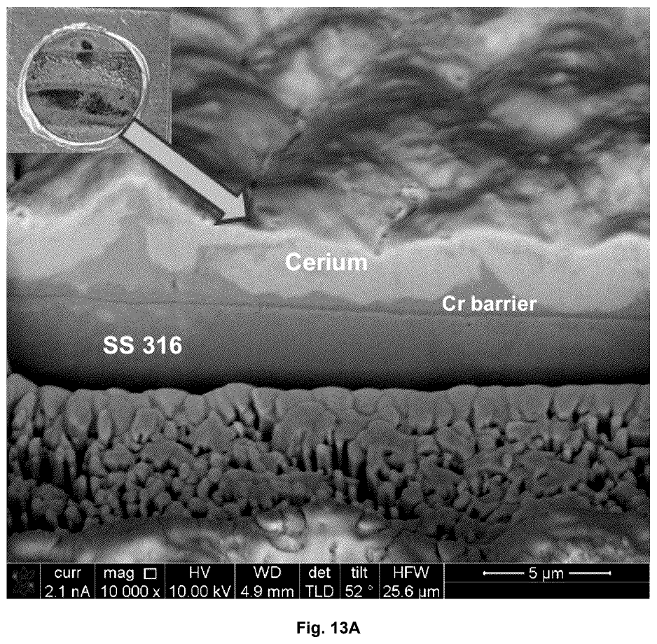

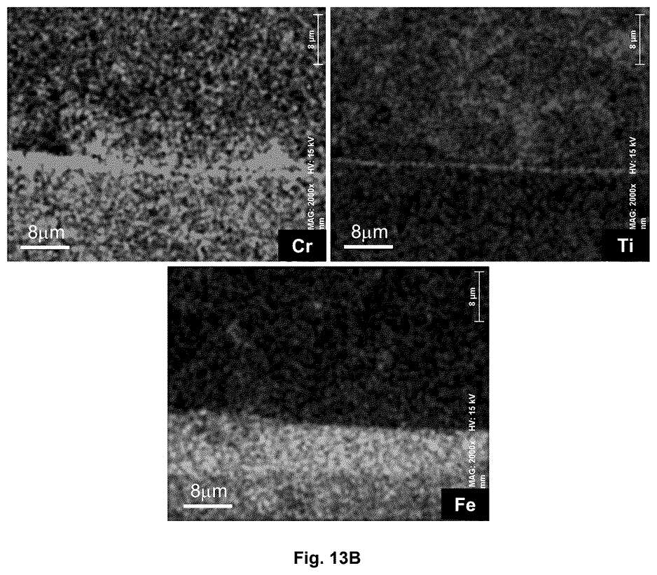

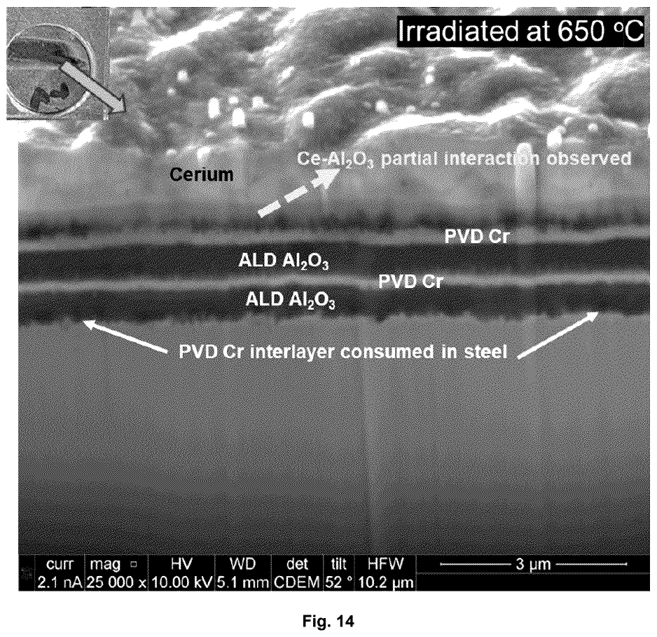

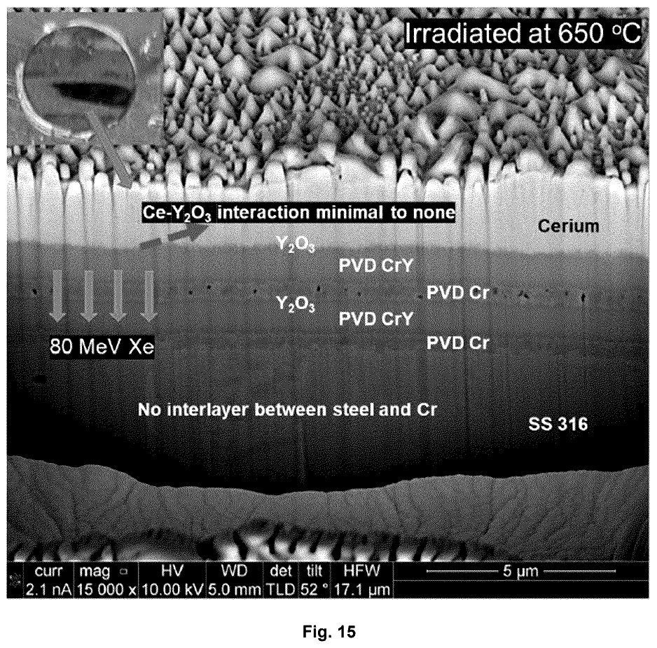

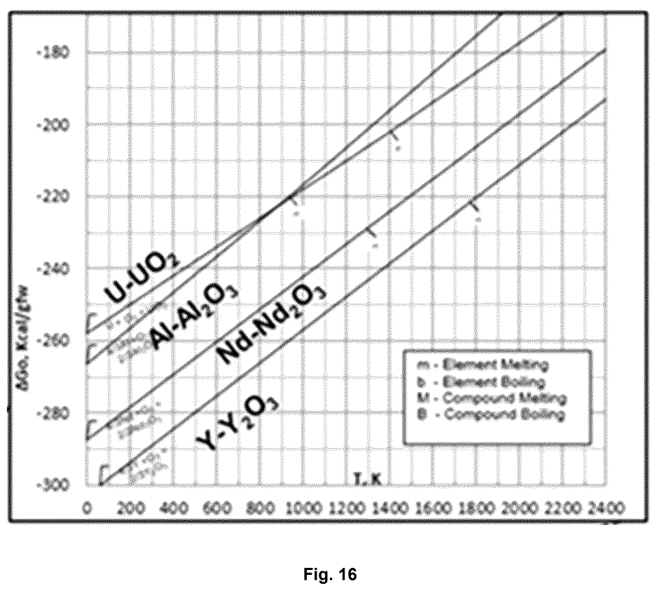

TABLE 4

| | Sample | 4A | 4B | 4C |
|---|---|---|---|---|
| Substrate | Material | SS316 | Fe | SS316 |
| | Barrier interface | — | Cr | Cr |
| Metal layers | Metal | Cr | Cr | Cr—Y |
| | No of layers | 1 | 3 | 2 |
| | Deposition | PVD | PVD | PVD |
| | method | | | |
| Ceramic | Ceramic | — | Al₂O₃ | Y₂O₃ |
| layers | No of layers | — | 3 | 2 |
| | Thickness (nm) | — | 600 | 100 |
| | Deposition | — | ALD | PVD + thermal |
| | method | | | oxidation |
| Treatment | Time (hr) | 12 | 12 | 12 |
| | Temperature (° C.) | 650 | 650 | 650 |
| | Radiation Dose | 4.53 E16 | 4.53 E16 | 4.53 E16 |
| | | ions/cm² | ions/cm² | ions/cm² |
| | Result | Ce migration | Cr interface | No signs of Ce |
| | | (FIG. 13A-13B) | diffusion into | penetration |
| | | | substrate, | into the barrier |
| | | | partial | (FIG. 15) |
| | | | interaction | |
| | | | between Ce | |
| | | | and the | |
| | | | topmost Al₂O₃ | |
| | | | layer (FIG. 14) | |

After treatment, samples were cross sectioned using Focus ion Beam (FIB). Scanning electron microscopy images and elemental EDS mappings of the cross sections were taken to analyze Ce migration through the barrier coatings and other structural damage.

Comparative barrier coating Sample 4A showed a strong interaction between the Ce and Cr layers, with Ce being able to reach the underlying stainless-steel substrate. Comparative coating 4B showed partial penetration of Ce into the Al₂O₃ layer directly exposed to fission products and diffusion of the Cr layer into the stainless-steel substrate.

Sample 4C containing Y-doped Cr metal layers, showed minimal to no interaction between the Ce and the Y₂O₃ layers and no Ce migration through the barrier layer.

Without intending to be limited by theory, it is believed that the addition of dopants or alloying metals, as shown in example 4C is necessary to overcome the limitation of metal layers formed of single metals (e.g., Cr), such as in the comparative coatings (e.g., 4A and 4B). Comparative coatings formed of single component metal layers were effective at temperatures between about 450° C. to about 500° C. but lost efficacy at elevated temperatures (e.g., 650° C. and above).

Without intending to be limited by theory, it is believed that the resistance to radiation induced damage of metal oxides increases proportionally to the difference between the Gibbs free energy of formation of UO₂ and the metal oxide

$$( Δ {G}_{{UO}_{2}}^{0} - Δ {G}_{m etal oxide}^{0} ) ,$$

with Al₂O₃ being at the stability boundary. Referring to FIG. 16, an Ellingham diagram can be used to estimate the stability of the metal oxide at a given temperature or temperature range. This diagram is useful in explaining the interaction observed in sample 4B, where the Al₂O₃ exposed to the fission products was partially penetrated by Ce (FIG. 14), referring to the diagram, the Gibbs free energy of Al₂O₃ can be observed to be lower than UO₂ at, for example, 200° C. (i.e., Al₂O₃ is more stable than UO₂), but this stability difference decreases with temperature and it is completely reversed at about 900° C., thus Al₂O₃ is expected to be less stable and more likely to be breached by fission products as temperature increases.

### Aspects

Aspect 1. A nuclear reactor coated cladding, comprising:
a steel cladding having opposed interior and exterior surface; and
a coating disposed on the interior surface of the steel cladding, wherein:
   the coating is a thermal and radiation resistant multilayer coating comprising:
      a ceramic layer in contact with the steel cladding,
      a metal oxide region separated from the ceramic layer by a metal layer,
      a metal nitride region separated from the metal oxide region by a metal layer, and the metal nitride region comprises at least two metal nitride layers and one or more metal layers, wherein each metal nitride layer is separated from an adjacent metal nitride layer by a metal layer of the one or more metal layers,
   the metal oxide region comprises at least two metal oxide layers and one or more metal layers, each metal oxide layer is separated from an adjacent metal oxide layer by a metal layer of the one or more metal layers,
   the metal layer separating the metal nitride region from the metal oxide region is disposed between a metal nitride layer and a metal oxide layer, and
   a thickness of the one or more metal layers in the metal nitride region is greater than a thickness of at least one of the one or more metal layers in the metal oxide region.

Aspect 2. The coated cladding of aspect 1, wherein the coated cladding has a gradient of thickness of metal layers present in the coating, with a thickness of the metal layers decreasing from the one or more metal layers present in the metal nitride region to the metal layer separating the metal oxide region from the ceramic layer.

Aspect 3. The coated cladding of aspect 2, wherein the gradient of thickness of the metal layers present in the coating is such that the atomic ratio of implanted solid fission products from a radioactive fuel decay to metal, when the coated cladding surrounds a nuclear fuel source is in each thickness 10 at % or less, for a lifetime of the nuclear fuel source.

Aspect 4. The coated cladding of any one of the preceding aspects, wherein each of the metal nitride layers of the metal nitride region has substantially the same thickness.

Aspect 5. The coated cladding of any one of the preceding aspects, wherein each of the metal oxide layers of the metal oxide region has substantially the same thickness.

Aspect 6. The coated cladding of any one of the preceding aspects, wherein the metal layer separating the metal nitride region from the metal oxide region has substantially the same thickness as the one or more metal layers of the metal nitride region.

Aspect 7. The coated cladding of any one of the preceding aspects, wherein the metal oxide region comprises at least one metal layer having a thickness substantially the same as a thickness of the metal layer separating the metal oxide region and the metal nitride region and at least one metal layer having a thickness that is less than a thickness of the metal layer separating the metal oxide region and the metal nitride region.

Aspect 8. The coated cladding of any one of the preceding aspects, wherein the total thickness of the coating is about 6 to 15 microns.

Aspect 9. The coated cladding of any one of the preceding aspects, wherein the coating comprises a total number of layers of about 4 to about 11.

Aspect 10. The coated cladding of any one of the preceding aspects, wherein metal nitride region comprises about 1 to about 2 nitride layers.

Aspect 11. The coated cladding of any one of the preceding aspects, wherein each metal nitride layer has a thickness of about 250 nm to about 350 nm.

Aspect 12. The coated cladding of any one of the preceding aspects, wherein the metal nitride layers are formed of a metal nitride with a Gibbs free energy of formation lower than a Gibbs free energy of formation of Uranium nitride at a transient temperature in the range of about 600° C. to about 800° C.

Aspect 13. The coated cladding of aspect 12, wherein the metal nitride is TIN, ZrN, YN, CrN or combinations thereof.

Aspect 14. The coated cladding of any one of the preceding aspects, wherein the metal oxide region comprises about 3 to about 4 metal oxide layers.

Aspect 15. The coated cladding of any one of the preceding aspects, wherein each metal oxide layer has a thickness of about 500 nm to about 1.5 microns.

Aspect 16. The coated cladding of any one of the preceding aspects, wherein the metal oxide layers are formed of a metal oxide that is thermally and chemically stable when mixed with rare earth elements.

Aspect 17. The coated cladding of any one of the preceding aspects, wherein the metal oxide layers are formed of one or more of Yttria (Y₂O₃), Yttria stabilized zirconia, alumina (Al₂O₃), lanthanide doped Y₂O₃, lanthanide doped Yttria stabilized zirconia, lanthanide doped Al₂O₃, and chromium oxide (Cr₂O₃).

Aspect 18. The coated cladding of any one of the preceding aspects, wherein the metal layers of the coating each comprises a metal that when in contact with Uranium forms as the lowest melting point eutectic phase a eutectic phase having a melting temperature higher than about 600° C.

Aspect 19. The coated cladding of any one of the preceding aspects, wherein the metal layers of the coating comprise one or more of Cr, V, Ti, Mo, Zr, Y, and alloys thereof.

Aspect 20. The coated cladding of aspect 19, wherein the metal is Al-doped Cr.

Aspect 21. The coated cladding of aspect 20, wherein the Al-doped Cr has a concentration of Al of about 5 at. % to about 10 at. %.

Aspect 22. The coated cladding of aspect 19, wherein the metal is Y-doped Cr.

Aspect 23. The coated cladding of aspect 22, wherein the Y-doped Cr has a concentration of Y of about 5 at. % to about 10 at. %.

Aspect 24. The coated cladding of any one of the preceding aspects, wherein a thickness of the one or more metal layers in the metal nitride region is about 2000 nm to about 3000 nm.

Aspect 25. The coated cladding of any one of the preceding aspects, wherein a thickness of the one or more metal layers in the metal oxide region is about 300 nm to about 2500 nm.

Aspect 26. The coated cladding of anyone of the preceding aspects, wherein the ceramic layer has a thickness of about 200 nm to about 250 nm.

Aspect 27. The coated cladding of any one of the preceding aspects, wherein the ceramic layer comprises one or more of TiN, Cr₂O₃, Al₂O₃, Y₂O₃, and ZrO₂.

Aspect 28. The coated cladding of any one of the preceding aspects, wherein the one or more metal layers in the coating comprise the same metal.

Aspect 29. The coated cladding of aspect 1, wherein:
the metal layer separating the metal oxide region from the ceramic layer is a first metal layer,
the metal oxide region comprises:
   a first metal oxide layer separated from a second metal oxide layer by a second metal layer, and
   a third metal oxide layer separate from the second metal oxide layer by a third metal layer,
the first metal layer is arranged between the ceramic layer and the first metal oxide layer,
the metal layer separating the metal oxide region from the metal nitride region is a fourth metal layer,
the metal nitride region comprises a first metal nitride layer separate from a second metal nitride layer by a fifth metal layer,
a thickness of the first and second nitride layers is substantially the same;
a thickness of the first, second and third oxide layers is substantially the same;
a thickness of the first and second metal layers is substantially the same;
a thickness of the third, fourth and fifth metal layers is substantially the same;
the thickness of the third, fourth, and fifth metal layers is greater than a thickness of the first and second metal layers.

Aspect 30. The coated cladding of aspect 1, wherein:
the metal layer separating the metal oxide region from the ceramic layer is a first metal layer,
the metal oxide layer comprises a first metal oxide layer separated from a second metal oxide layer by a second metal layer,
the first metal layer is arranged between the ceramic layer and the first metal oxide layer,
the metal layer separating the metal oxide region from the metal nitride region is a third metal layer,
the metal nitride region comprises a first metal nitride layer separate from a second metal nitride layer by a fourth metal layer,
a thickness of the first and second nitride layers is substantially the same;
a thickness of the first and second oxide layers is substantially the same;
a thickness of the first and second metal layers is substantially the same;
a thickness of the third and fourth metal layers is substantially the same;
the thickness of the third and fourth metal layers is greater than a thickness of the first and second metal layers.

Aspect 31. A nuclear fuel source surrounded by the coated cladding of any one of the preceding aspects, wherein one metal nitride layer of the metal nitride region is in contact with the fuel source.

Aspect 32. A nuclear fuel source comprising a Uranium-based alloy, a Uranium oxide, or combinations thereof.

Aspect 33. A nuclear fuel rod comprising the coated cladding of any one of the preceding aspects, wherein one metal nitride layer of the metal nitride region is in contact with a fuel source contained within the fuel rod.

### REFERENCES

(1) G. L. Hofman, R. G. Pahl, C. E. Lahm, D. L. Porter, Swelling behavior of U—Pu—Zr fuel, Metall. Trans. A. 21 (1990) 517-528. Doi: 10.|007/BF0267|924.
(2) A. B. Cohen; H. Tsai, L. A. Neimark, Fuel/cladding compatibility in U-19Pu-10Zr/HT9-clad fuel at elevated temperatures, J. Nucl. Mater. 204 (1993) 244-251.
(3) Ho Jin Ryu, Byoung Oon Lee, Seok Jin Oh, Jun Hwan Kim, Chan Bock Lee, Performance of FCCI barrier foils for U—Zr—X metallic fuel, Journal of Nuclear Materials, Volume 392, Issue 2, 2009.
(4) Christopher Matthews, Cetin Unal, Jack Galloway, Dennis D. Keiser Jr. & Steven L. Hayes (2017) Fuel-Cladding Chemical Interaction in U—Pu—Zr Metallic Fuels: A Critical Review, Nuclear Technology, 198:3, 31-25.
(5) Okamoto, H. Ce—Fe (Cerium-Iron). J Phs Eqil and Dif. 129, 1|6-1|7 (2008).
(6) Okamoto, H. Ce—Ni (Cerium-Nickel). J. Phase Equilib. Dif.fus. 30, 407 (2009).
(7) Von Goldbeck, O. K. (1982). Iron-Uranium Fe—U. In: IRON-Binary Phase Diagrams. Springer, Berlin, Heidelberg.
(8) J. F. Ziegler, Ion Implantation Science and Technology (second ed.), Elsevier (1988), pp. 3-61.
(9) Sumit Bhattacharya, Xiang Liu, Yinbin Miao, Kun Mo, Zhi-Gang Mei, Laura Jamison, Walid Mohamed, Aaron Oaks, Ruqing Xu, Shaofei Zhu, James F. Stubbins, Abdellatif M. Yacout, Interaction between Al and atomic layer deposited (ALD) ZIN under high-energy heavy ion irradiation, Acta Materialia, Volume 164, 2019.
(10) Okamoto, H. Ti—U (Titanium-Uranium). J. Phase Equilib. Dif.fus. 34, 61-62 (2013).
(11) Predel, F. (2016). Phase diagram of U—V (uranium-vanadium) system.
(12) Okamoto, H. Cr—U (Chromium-Uranium). J. Phase Equilib. Dif.fus. 33,495 (2012).
(13) A. Palenzona and S. Cirafici, Bulletin of Alloy Phase Diagrams Vol. 11 No. 5, 1990.
(14) Ce—Ti Binary Phase Diagram 98-100 at. % Ti: Datasheet from “PAULING FILE Multinaries Edition—2022” in Springer Materials.
(15) A. Palenzona and S. Cirafici, Journal of Phase Equilibria Vol. 17 No. 1, 1996.
(16) Smith, J. F., Lee, K. J. The Ce—V (Cerium-Vanadium) system. Bulletin of Alloy Phase Diagrams 8, 523-525 (1987).
(17) Fast reactor fission yields for ²³³U and ²³⁵U irradiated in Row 4 of EBR-11. United States: N. p., 1980.
(18) D. Mohr, L. K. Chang, E. E. Feldman, P. R. Betten, H. P. Planchon, Loss-of-primary-flow-without-scram tests: Pretest predictions and preliminary results, Nuclear Engineering and Design, Vol. 101, No 1, 1987, pp. 45-56.
(19) H Joswig, W Pamler, Stoichiometry effects in TiN diffusion barriers, Thin Solid Films, Vol. 221, No. 1-2, 1992, pp. 228-232.
(20) R. G. Pahl, C. E. Lahm, S. L. Hayes, Performance of HT9 clad metallic fuel at high temperature, J. of Nuclear Materials, 204 (1993), pp 141-147.

What is claimed is:

1. A nuclear reactor coated cladding, comprising:
a steel cladding having opposed interior and exterior surface; and
a coating disposed on the interior surface of the steel cladding, wherein:
the coating is a thermal and radiation resistant multilayer coating comprising:
a ceramic layer in contact with the steel cladding,
a metal oxide region separated from the ceramic layer by a metal layer,
a metal nitride region separated from the metal oxide region by a metal layer, and the metal nitride region comprises at least two metal nitride layers and one or more metal layers, wherein each metal nitride layer is separated from an adjacent metal nitride layer by a metal layer of the one or more metal layers,
the metal oxide region comprises at least two metal oxide layers and one or more metal layers, each metal oxide layer is separated from an adjacent metal oxide layer by a metal layer of the one or more metal layers,
the metal layer separating the metal nitride region from the metal oxide region is disposed between a metal nitride layer and a metal oxide layer, and
a thickness of the one or more metal layers in the metal nitride region is greater than a thickness of at least one of the one or more metal layers in the metal oxide region.

2. The coated cladding of claim 1, wherein the coated cladding has a gradient of thickness of metal layers present in the coating, with a thickness of the metal layers decreasing from the one or more metal layers present in the metal nitride region to the metal layer separating the metal oxide region from the ceramic layer.

3. The coated cladding of claim 1, wherein the metal layer separating the metal nitride region from the metal oxide region has substantially the same thickness as the one or more metal layers of the metal nitride region.

4. The coated cladding of claim 1, wherein the metal oxide region comprises at least one metal layer having a thickness substantially the same as a thickness of the metal layer separating the metal oxide region and the metal nitride region and at least one metal layer having a thickness that is less than a thickness of the metal layer separating the metal oxide region and the metal nitride region.

5. The coated cladding of claim 1, wherein the total thickness of the coating is about 6 to 15 microns.

6. The coated cladding of claim 1, wherein the coating comprises a total number of layers of about 4 to about 11.

7. The coated cladding of claim 1, wherein metal nitride region comprises about 1 to about 2 nitride layers and each metal nitride layer has a thickness of about 250 nm to about 350 nm.

8. The coated cladding of claim 1, wherein the metal nitride layers are formed of a metal nitride with a Gibbs free energy of formation lower than a Gibbs free energy of formation of Uranium nitride at a transient temperature in the range of about 600° C. to about 800° C.

9. The coated cladding of claim 8, wherein the metal nitride is TIN, ZrN, YN, CrN or combinations thereof.

10. The coated cladding of claim 1, wherein the metal oxide layers are formed of a metal oxide that is thermally and chemically stable when mixed with rare earth elements.

11. The coated cladding of claim 1, wherein the metal oxide layers are formed of one or more of Yttria (Y₂O₃), Yttria stabilized zirconia, alumina (Al₂O₃), lanthanide doped Y₂O₃, lanthanide doped Yttria stabilized zirconia, lanthanide doped Al₂O₃, and chromium oxide (Cr₂O₃).

12. The coated cladding of claim 1, wherein the metal layers each comprises a metal that when in contact with Uranium forms as the lowest melting point eutectic phase a eutectic phase having a melting temperature higher than about 600° C.

13. The coated cladding of claim 1, wherein the metal layers of the coating comprise one or more of Cr, V, Ti, Mo, Zr, Y, and alloys thereof.

14. The coated cladding of claim 13, wherein the metal is Al-doped Cr having a concentration of Al of about 5 at. % to about 10 at. % or the metal is Y-doped Cr having concentration of Y of about 5 at. % to about 10 at. %.

15. The coated cladding of claim 1, wherein a thickness of the one or more metal layers in the metal nitride region is about 2000 nm to about 3000 nm; and/or wherein a thickness of the one or more metal layers in the metal oxide region is about 300 nm to about 2500 nm; and/or wherein the ceramic layer has a thickness of about 200 nm to about 250 nm.

16. The coated cladding of claim 1, wherein the ceramic layer comprises one or more of TiN, Cr₂O₃, Al₂O₃, Y₂O₃, and ZrO₂.

17. The coated cladding of claim 1, wherein:
the metal layer separating the metal oxide region from the ceramic layer is a first metal layer,
the metal oxide region comprises:
a first metal oxide layer separated from a second metal oxide layer by a second metal layer, and
a third metal oxide layer separate from the second metal oxide layer by a third metal layer,
the first metal layer is arranged between the ceramic layer and the first metal oxide layer,
the metal layer separating the metal oxide region from the metal nitride region is a fourth metal layer,
the metal nitride region comprises a first metal nitride layer separate from a second metal nitride layer by a fifth metal layer,
a thickness of the first and second nitride layers is substantially the same;
a thickness of the first, second and third oxide layers is substantially the same;
a thickness of the first and second metal layers is substantially the same;
a thickness of the third, fourth and fifth metal layers is substantially the same;
the thickness of the third, fourth, and fifth metal layers is greater than a thickness of the first and second metal layers.

18. The coated cladding of claim 1, wherein:
the metal layer separating the metal oxide region from the ceramic layer is a first metal layer,
the metal oxide layer comprises a first metal oxide layer separated from a second metal oxide layer by a second metal layer,
the first metal layer is arranged between the ceramic layer and the first metal oxide layer,
the metal layer separating the metal oxide region from the metal nitride region is a third metal layer,
the metal nitride region comprises a first metal nitride layer separate from a second metal nitride layer by a fourth metal layer,
a thickness of the first and second nitride layers is substantially the same;
a thickness of the first and second oxide layers is substantially the same;
a thickness of the first and second metal layers is substantially the same;
a thickness of the third and fourth metal layers is substantially the same;
the thickness of the third and fourth metal layers is greater than a thickness of the first and second metal layers.

19. A nuclear fuel source surrounded by the coated cladding of claim 1, wherein one metal nitride layer of the metal nitride region is in contact with the fuel source.

20. A nuclear fuel rod comprising the coated cladding of claim 1, wherein one metal nitride layer of the metal nitride region is in contact with a fuel source contained within the fuel rod.
